(19) United States
(12) Patent Application Publication
(10) Pub. No.: US 2025/0258454 A1
(43) Pub. Date: Aug. 14, 2025

(54) INFORMATION PROCESSING APPARATUS, IMAGE FORMING APPARATUS, MANAGEMENT SYSTEM, AND STORAGE MEDIUM

(71) Applicant: Konica Minolta, Inc., Tokyo (JP)

(72) Inventor: Takashi KAWANAGO, Tokyo (JP)

(21) Appl. No.: 19/045,288

(22) Filed: Feb. 4, 2025

(30) Foreign Application Priority Data
Feb. 13, 2024 (JP) 2024-019161

(51) Int. Cl. G03G 15/00

(52) U.S. Cl. CPC G03G 15/556

(57) ABSTRACT

An information processing apparatus includes a hardware processor. The hardware processor acquires predetermined data that affects a lifetime of a consumable component from a plurality of image forming apparatuses installed in different environments, calculates, based on the predetermined data, information on the lifetime of a predetermined consumable component included in each image forming apparatus, and transmits the information on the lifetime to the image forming apparatus.

### CROSS-REFERENCE TO RELATED APPLICATIONS

The entire disclosure of Japanese Patent Application No. 2024-019161 filed on Feb. 13, 2024, is incorporated herein by reference in its entirety.

### BACKGROUND OF THE INVENTION

### Technical Field

The present invention relates to an information processing apparatus, an image forming apparatus, a management system, and a storage medium.

### Description of Related Art

Conventionally, image forming apparatuses include many consumable components having a fixed lifetime. In general, their lifetimes are uniquely determined. However, the lifetime of each consumable component can change to be longer or shorter depending on how the image forming apparatus is used. Therefore, it is preferable to grasp how the image forming apparatus is used and change the consumable component so that the lifetime of the consumable component can be used up to the end.

Japanese Unexamined Patent Publication No. 2022-164361 describes a method of calculating a time to reach the end of lifetime of a consumable component from use result information in a single image forming apparatus.

Japanese Unexamined Patent Publication No. 2018-170629 describes a method of collecting use result information from a plurality of image forming apparatuses and diagnosing an abnormality. Here, the abnormality diagnosis is, for example, to calculate the probability of occurrence of a trouble such as the probability of occurrence of JAM, and to diagnose that there is an abnormality when the value is larger than a preset threshold value.

In Japanese Unexamined Patent Publication No. 2022-164361, the method of calculating the lifetime expiration time of a consumable component is not automatically updated, and therefore, the accuracy of the method of calculating the lifetime expiration time is not improved from the time point at which the image forming apparatus is provided to a user.

However, the technique described in Japanese Unexamined Patent Publication No. 2018-170629 is for diagnosing an abnormality and is not for predicting the lifetime of the consumable component.

### SUMMARY OF THE INVENTION

An object of the present invention is to improve lifetime prediction accuracy of a consumable component in an image forming apparatus.

To achieve at least one of the abovementioned objects, according to an aspect of the present invention, an information processing apparatus reflecting one aspect of the present invention is an information processing apparatus including: a hardware processor, wherein the hardware processor, acquires predetermined data that affects a lifetime of a consumable component from a plurality of image forming apparatuses installed in different environments, calculates, based on the predetermined data, information on the lifetime of a predetermined consumable component included in each image forming apparatus, and transmits the information on the lifetime to the image forming apparatus.

According to another aspect of the present invention, an image forming apparatus reflecting one aspect of the present invention is an image forming apparatus including a predetermined consumable component, the apparatus including: a receiver that receives the information on the lifetime from the information processing apparatus according to the above; and a hardware processor, wherein the hardware processor, calculates the lifetime of the consumable component from the information on the lifetime, and updates the lifetime of the consumable component based on a calculation result.

According to another aspect of the present invention, a management system reflecting one aspect of the present invention is a management system including: a first hardware processor and a second hardware processor, wherein, the first hardware processor, acquires predetermined data that affects a lifetime of a consumable component from a plurality of image forming apparatuses installed in different environments, and calculates, based on the predetermined data, information on the lifetime of a predetermined consumable component included in each image forming apparatus, and the second hardware processor calculates the lifetime of the consumable component of one image forming apparatus from the information on the lifetime.

According to another aspect of the present invention, a storage medium reflecting one aspect of the

present invention is a non-transitory computer-readable storage medium storing a program that causes a computer of an information processing apparatus to perform, acquiring predetermined data that affects a lifetime of a consumable component from a plurality of image forming apparatuses installed in different environments, calculating, based on the predetermined data, information on the lifetime of a predetermined consumable component included in each image forming apparatus, and transmitting the information on the lifetime to the image forming apparatus.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a diagram illustrating an overall configuration of a management system;

FIG. 2 is a block diagram illustrating a functional configuration of a server;

FIG. 3 is a diagram illustrating a schematic configuration of an image forming apparatus;

FIG. 4 is a schematic cross-sectional view of a periphery of a cleaning device.

FIG. 5 is a block diagram illustrating a functional configuration of the image forming apparatus.

FIG. 6 is a flowchart illustrating lifetime coefficient calculation processing;

FIG. 7 is a table illustrating a relationship between consumable components and affecting factors;

FIG. 8 is an example of data transmitted from the image forming apparatus to the server;

FIG. 9 is an example of calculation data in the server; and

FIG. 10 is a flowchart illustrating lifetime calculation processing.

### DETAILED DESCRIPTION

Hereinafter, one or more embodiments of the present invention will be described with reference to the drawings. However, the scope of the invention is not limited to the disclosed embodiments.

In the following, embodiments of the present invention will be described in detail with reference to the drawings. However, the scope of the invention is not limited to the illustrated examples.

### <Configuration of Management System 100>

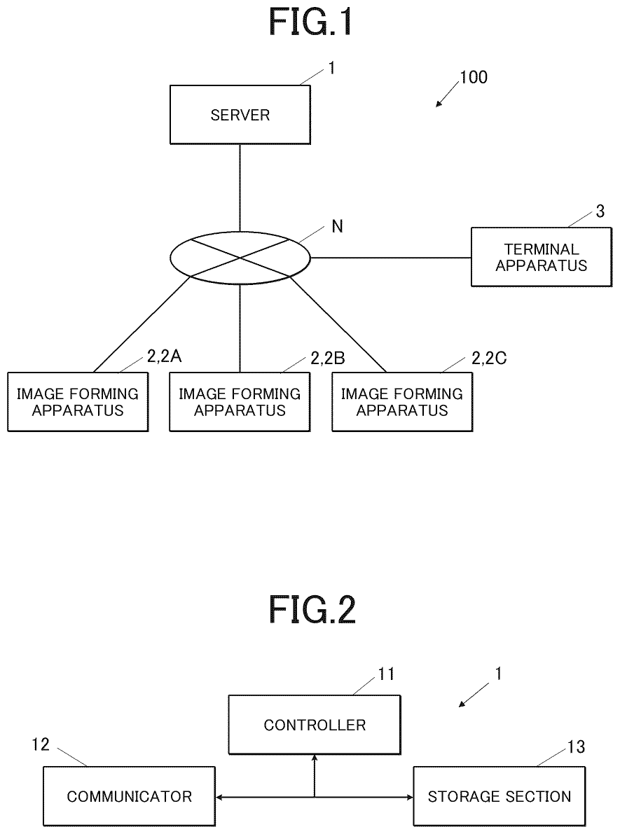

FIG. 1 shows a system configuration of a management system 100.

As illustrated in FIG. 1, in the management system 100, a plurality of image forming apparatuses 2 are connected to a server 1 (information processing apparatus). The server 1 is an information processing apparatus such as a cloud server or an on-premise server.

Here, the plurality of image forming apparatuses 2 are arranged in different environments. The environment means a place (country or city) where the image forming apparatus 2 is installed, a temperature and humidity environment around the image forming apparatus 2, a service base in charge of maintenance and inspection of the image forming apparatus 2, a range covered by a service person, and furthermore, the scale and industry of a company that has purchased the image forming apparatus 2.

Further, a terminal apparatus 3 is connected to the server 1 and the image forming apparatus 2. The terminal apparatus 3 is a terminal apparatus for the service person who performs maintenance and inspection of the image forming apparatus 2.

The respective devices are connected to each other via a network N such as a wired local area network (LAN) or a wireless LAN so as to be able to perform data communication.

### <Configuration of Server 1>

FIG. 2 shows a functional configuration of the server 1.

As illustrated in FIG. 2, the server 1 includes a controller 11 (hardware processor), a communicator 12, and a storage section 13, and these sections are connected to each other by a bus.

The controller 11 is composed of a central processing unit (CPU), a random access memory (RAM), a read only memory (ROM) and the like, and comprehensively controls processing operation of each part of the server 1.

Specifically, the CPU reads various processing programs stored in the ROM or the storage section 13 in response to an instruction signal received by the communicator 12. The CPU develops the program in a work area formed in the RAM, and performs various processes in cooperation with the program.

Here, functions of the controller 11 will be described.

The controller 11 functions as an acquisition section that acquires predetermined data affecting the lifetime of a consumable component from a plurality of image forming apparatuses installed in different environments.

The predetermined data includes at least three of customer attribution data, consumable component replacement information, and working data.

The customer attribution data is information on a customer who introduced the image forming apparatus 2. As an example of the customer attribution data, a place (country, city) where the image forming apparatus 2 is installed, an organization and a service person in charge of maintaining the image forming apparatus 2, a scale of a customer company, a business category of the customer company, a working time of the image forming apparatus 2(24-hour system, Saturday and Sunday holiday, irregular work) and the like correspond. In addition to this, if the data belongs to the customer and as long as it does not deviate from the intended purpose, the item belongs to the customer attribution data.

The consumable component replacement information is information on replacement of the consumable component. An example of the consumable component replacement information includes a lifetime expectancy (durable number of sheets) at the time of replacement of the consumable component, a sliding distance, an energization time, and a reason for replacement (predictive replacement, periodic replacement, or the like). However, in addition to this, as long as it does not depart from the intended purpose, other items may belong to the consumable component replacement information.

The working data is information related to the work of the consumable component. The working data includes data corresponding to a plurality of types of affecting factors that affect the lifetime. In addition, the consumable component is associated with an affecting factor that affects the lifetime of the consumable component. Examples of the affecting factors of the working data include an installation environment (temperature and humidity) of the image forming apparatus 2, an in-apparatus environment (temperature and humidity) of the image forming apparatus 2, average coverage or partial coverage for each toner, a paper type history, and a basis weight band history. However, in addition to this, as long as it does not depart from the intended purpose, other items may belong to the working data. Note that the average coverage is obtained by averaging the amount of each toner consumed in a predetermined period (the number of durable sheets or durable time). Further, the partial coverage is calculated by dividing the amount consumed for each toner into a plurality of segments in a rotation axis direction of a photosensitive drum.

Furthermore, the controller 11 functions as a first calculation section that calculates, based on the predetermined data, information on the lifetime of the predetermined consumable component included in each image forming apparatus. The controller 11 serves as a first calculation section to calculate information on the lifetime using the working data. The controller 11 serves as a first calculation section to correct information on the lifetime using the customer attribution data. Furthermore, the controller 11 serves as the first calculation section to calculate information on the lifetime of the consumable component for each affecting factor. The calculation method will be described later.

The information on the lifetime is information used in lifetime calculation processing performed in the image forming apparatus. For example, the information related to the lifetime is a lifetime coefficient when the lifetime of the consumable component is calculated.

The controller 11 functions as a transmission controller that transmits information on the lifetime to the image forming apparatus.

The controller 11 transmits information on the lifetime of each consumable component to the plurality of image forming apparatuses 2 connected to the network N periodically or in response to a transmission request from each image forming apparatus 2.

Even when a service person uses the terminal apparatus 3 to make a transmission request, the transmission request can be transmitted to any image forming apparatus 2.

The communicator 12 is an interface that transmits and receives data to and from an external device such as the image forming apparatus 2 or the terminal apparatus 3.

The storage section 13 is constituted by a hard disk or the like, and stores various data.

### <Configuration of Image Forming Apparatus 2>

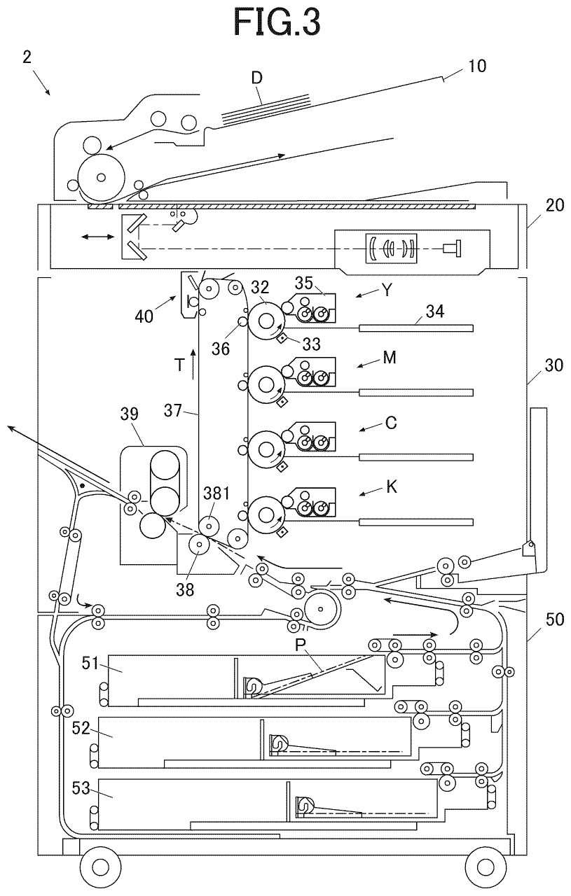

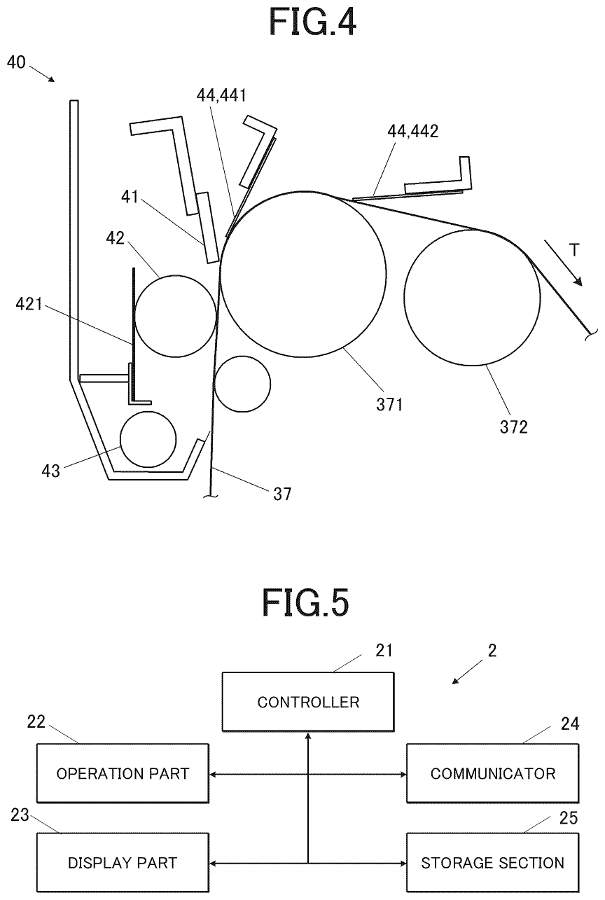

First, a schematic configuration of the image forming apparatus 2 will be described with reference to FIG. 3 and FIG. 4.

FIG. 3 illustrates a schematic configuration of the image forming apparatus 2. FIG. 4 is a schematic cross-sectional view of the periphery of the cleaning device.

As shown in FIG. 3, the image forming apparatus 2 includes an automatic document conveyor 10, a scanner 20, an image forming section 30, a sheet feed section 50, and the like. The image forming apparatus 2 further includes consumable components such as an intermediate transfer belt 37 (intermediate transfer belt), a cleaning blade 41 (blade), an auxiliary scraper 44 (scraper), a primary transfer roller 36 (primary transfer roller), and a secondary transfer roller 38 (secondary transfer roller).

The automatic document conveyor 10 conveys a document D placed on a document tray one by one to a predetermined conveyance path.

The scanner 20 irradiates the conveyed document D with a light source, and receives reflected light reflected from the document D. The scanner 20 converts the received optical signal into an electrical signal (image data), and outputs the electrical signal to the image forming section 30.

The sheet feed section 50 includes a plurality of sheet feed trays 51 to 53 that store recording material P, and feeds the recording material P to the image forming section 30 through a predetermined conveyance path.

The image forming section 30 includes a yellow imaging section Y, a magenta imaging section M, a cyan imaging section C, a black imaging section K, the intermediate transfer belt 37, the secondary transfer roller 38, and a cleaning device 40.

The imaging sections YMCK form yellow, magenta, cyan, and black images (toner images), respectively, on photoreceptors 32, and primarily transfer the toner images in the respective colors of Y, M, C, and K formed on the photoreceptors 32 to the intermediate transfer belt 37. Each of the imaging sections YMCK includes the photoreceptor 32, a charging device 33, an exposure device 34, a developing device 35, and the primary transfer roller 36.

Note that since the configurations and the operations of the imaging sections YMCK are the same, the yellow imager Y will be described below as an example.

The photoreceptor 32 is a drum-shaped image bearing member that bears an image (toner image) on a surface thereof. The photoreceptor 32 is formed of an organic photoreceptor in which a photosensitive layer formed of a resin containing an organic photoconductor is formed on an outer circumferential surface of a drum-shaped metal substrate, and is rotationally driven in a counterclockwise direction in the drawing. Examples of resins constituting the photosensitive layer include polycarbonate resin; silicone resin; polystyrene resin; acrylic resin; methacrylic resin; epoxy resin; polyurethane resin; vinyl chloride resin and melamine resins.

The charging device 33 uniformly charges the surface of the photoreceptor 32 to a constant potential.

The exposure device 34 exposes a non-image region of the photoreceptor 32 on the basis of image data from the scanner 20, and eliminates electric charge of the exposed portion, thereby forming an electrostatic latent image in an image region of the photoreceptor 32.

The developing device 35 supplies toner, which is a developer, onto the electrostatic latent image formed on the photoconductor 32 to form the toner image on the photoreceptor 32.

The primary transfer roller 36 primarily transfers the toner image formed on the photoreceptor 32 onto the intermediate transfer belt 37.

The intermediate transfer belt 37 is a belt-like image bearing member which is stretched around a plurality of rollers including rollers 371 and 372 (see FIG. 4), bears an image (toner image) on its surface, and conveys the image in its conveyance direction T, and is rotationally driven with the rotation of the rollers. The intermediate transfer belt 37 is pressed against each of the opposing photoreceptors 32 by the primary transfer roller 36, and the toner image developed on the surface of the photoreceptor 32 is primarily transferred.

The secondary transfer roller 38 is disposed in contact with a secondary transfer counter roller 381 via the intermediate transfer belt 37. The toner images on the intermediate transfer belt 37 are secondarily transferred onto the recording material P by the recording material P passing through the transfer nip formed between the secondary transfer roller 38 and the secondary transfer counter roller 381.

On an ejection side of the recording material P with respect to the secondary transfer roller 38, a fixing device 39 is arranged. The fixing device 39 heats and pressurizes the toner image formed on the conveyed recording material P to fix the toner image on the recording material P.

FIG. 4 is a schematic sectional view of the periphery of the cleaning device 40.

The cleaning device 40 cleans the intermediate transfer belt 37 after the secondary transfer and removes residual toner and the like (residues such as residual toner, paper dust, and external additives) that are not transferred onto the recording material P and adhere to the intermediate transfer belt 37.

Specifically, as shown in FIG. 4, the cleaning device 40 includes the cleaning blade 41, a storage roller 42, a waste toner screw 43, and the two auxiliary scrapers 44 (a first scraper 441 and a second scraper 442). The cleaning device 40 is provided in the vicinity of the roller 371 that stretches the intermediate transfer belt 37.

Note that hereinafter, a downstream side in the conveyance direction T of the intermediate transfer belt 37 may be simply referred to as “downstream side”, and an upstream side in the conveyance direction T may be simply referred to as “upstream side”.

The cleaning blade 41 is an example of a third cleaning member according to the present embodiment. The cleaning blade 41 is in contact with the surface of the intermediate transfer belt 37 with its tip end facing the roller 371 via the intermediate transfer belt 37, and scrapes (wipes) residual toner and the like adhering to the surface of the intermediate transfer belt 37. The cleaning blade 41 is formed in the shape of a plate, and is in contact with the surface of the intermediate transfer belt 37 over substantially the entire length in the width direction of the intermediate transfer belt 37 (the direction perpendicular to the sheet surface of FIG. 4) and in contact therewith in a counter direction to the conveyance direction T of the intermediate transfer belt 37.

The cleaning blade 41 according to the present embodiment is a urethane rubber blade with a hardness of 74 degrees (JISA: same applies hereinafter). The cleaning blade 41 is to be made of rubber having a hardness of less than 78 degrees. As described above, by using the rubber blade having a relatively low hardness as the cleaning blade 41, a large amount of residual toner and the like can be wiped off.

The storage roller 42 is disposed on the upstream side of the cleaning blade 41 in the conveyance direction T and below the cleaning blade 41, and is provided so as to come into contact with the surface of the intermediate transfer belt 37. The storage roller 42 is rotated by a driving unit (not shown) in a rotation direction along the conveyance direction T of the intermediate transfer belt 37.

On the surface of the storage roller 42, at a position opposite to the contact position with the intermediate transfer belt 37, a storage plate 421 provided standing substantially vertically and made of metal is in contact with the storage roller 42. A space surrounded by the intermediate transfer belt 37, the storage roller 42, and the storage plate 421 in this manner forms a storage space that stores the residual toner and the like wiped from the surface of the intermediate transfer belt 37 by the cleaning blade 41.

The waste toner screw 43 is configured to be rotatable by a driving means (not illustrated), and collects and discharges residual toner and the like that have dropped from the storage space above.

Two auxiliary scrapers 44 are disposed downstream from the cleaning blade 41 in the conveyance direction T, and remove, from the surface of the intermediate transfer belt 37, residual toner and the like that have passed through the cleaning blade 41. These auxiliary scrapers 44 are formed in a plate shape, and abut against the surface of the intermediate transfer belt 37 over substantially the entire length in the width direction of the intermediate transfer belt 37, and also abut against the intermediate transfer belt 37 in a counter direction with respect to the conveyance direction T of the intermediate transfer belt 37.

Among these, the first scraper 441 is an example of a first cleaning member according to the present embodiment. The first scraper 441 is disposed immediately downstream from the cleaning blade 41, and is in contact with the surface of the intermediate transfer belt 37 with its tip end facing the roller 371 via the intermediate transfer belt 37. The roller 371 may be a drive roller.

On the other hand, the second scraper 442 is an example of a second cleaning member according to the present embodiment. The second scraper 442 is disposed on the downstream side of the first scraper 441, and the tip thereof is in contact with the surface of the intermediate transfer belt 37 without facing any member via the intermediate transfer belt 37.

The materials of the two auxiliary scrapers 44 are both stainless steel in the present embodiment. However, the two auxiliary scrapers 44 may be made of metal or resin having a hardness of 78 degrees or more. In this way, by using a material having a relatively high hardness as the auxiliary scraper 44, it is possible to suitably remove the residual toner and the like without causing chipping and dragging which occur in a case of using a rubber blade. Furthermore, in the present embodiment, since the cleaning blade 41 made of rubber wipes off a large amount of residual toner and the like, only a relatively small amount of residual toner and the like reaches the two auxiliary scrapers 44 on the downstream side thereof, chipping and dragging are particularly less likely to occur.

Note that when the auxiliary scraper 44 is made of metal, it is preferable to form a coating layer (protective layer) of diamond-like carbon on the surface of the auxiliary scraper 44. Thus, abrasion of a base metal of the auxiliary scraper 44 and damage to the intermediate transfer belt 37 by the auxiliary scraper 44 can be suppressed.

Next, the functional configuration of the image forming apparatus 2 will be described with reference to FIG. 5.

FIG. 5 illustrates a functional configuration of the image forming apparatus 2.

As illustrated in FIG. 5, the image forming apparatus 2 includes a controller 21 (hardware processor), an operation part 22, a display part 23, a communicator 24, and a storage section 25, and these units are connected to each other via a bus.

The controller 21 is composed of a central processing unit (CPU), a random access memory (RAM), a read only memory (ROM) and the like, and comprehensively controls processing operation of each part of the image forming apparatus 2.

To be specific, the CPU reads various processing programs stored in the ROM or the storage section 25 in response to an operation signal input from the operation part 22 or an instruction signal received by the communicator 24. The CPU develops the program in a work area formed in the RAM, and performs various processes in cooperation with the program.

The controller 21 functions as a second calculation section that calculates the lifetime of the consumable component from the information on the lifetime. The calculation method will be described later.

The controller 21 functions as a lifetime updating section which updates the lifetime of the consumable component on the basis of the calculation result by the second calculation section.

The operation part 22 includes a keyboard including cursor keys, number input keys, and various function keys, and a pointing device such as a mouse, and outputs, to the controller 11, an operation signal input by a key operation on the keyboard or a mouse operation.

The display part 23 includes a liquid crystal display (LCD), and displays various screens based on display data input from the controller 11.

The communicator 24 is an interface that transmits and receives data to and from other image forming apparatuses 2 and external devices such as the image forming apparatuses 2.

The communicator 24 functions as a receiver that receives information on the lifetime from the server 1 which functions as the information processing apparatus.

The storage section 25 includes a hard disk and the like, and stores various types of data.

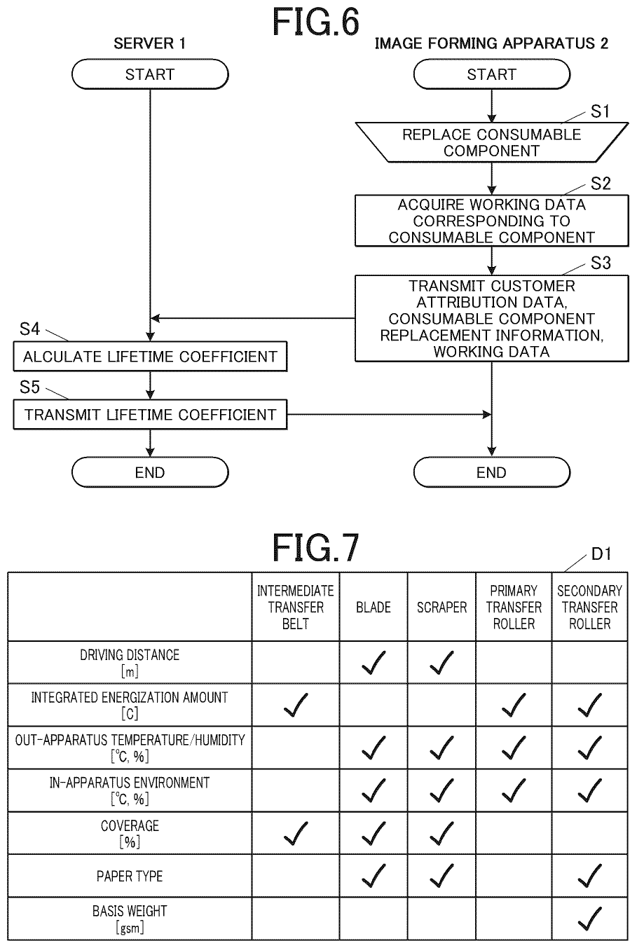

To be specific, the storage section 25 stores the above-described data, a table D1 (FIG. 7) indicating a relationship between the consumable components and the affecting factors, and the like.

Similarly to the server 1, the data includes at least three of customer attribution data, consumable component replacement information, and working data. In addition, the data may include climate forecast information on a region where the image forming apparatus 2 is installed.

### <Lifetime Coefficient Calculation Processing>

The lifetime coefficient calculation processing executed in the server 1 will be described with reference to FIG. 6.

The lifetime coefficient calculation processing is processing for calculating a lifetime coefficient as information related to lifetime.

The lifetime coefficient calculation processing will be described as an example of the processing of calculating information on the lifetime, but the present invention is not limited to this example. Other examples will be described later.

First, the user replaces the consumable component of the image forming apparatus 2 (step S1).

Next, the controller 21 of the image forming apparatus 2 acquires the working data of the affecting factor corresponding to the consumable component from the storage section 25 (step S2).

To be specific, the controller 21 specifies an affecting factor corresponding to the consumable component by using the table D1 indicating the relationship between the consumable component and the affecting factor illustrated in FIG. 7, and acquires the working data of the affecting factor.

For example, in FIG. 7, the integrated energization amount and the coverage of the intermediate transfer belt are factors that affect the lifetime thereof. Furthermore, the lifetime of the primary transfer roller is affected by the integrated energization amount, the temperature and humidity outside the apparatus (out-apparatus temperature/humidity), and the in-apparatus environment.

Here, in a case where the intermediate transfer belt is replaced, the controller 21 acquires consumable component replacement information and working data on the integrated energization amount and the coverage in a period from the last replacement of the intermediate transfer belt to the current replacement of the intermediate transfer belt.

Similarly, in a case where the primary transfer roller is replaced, the controller 21 acquires the consumable component replacement information, and the working data on the integrated energization amount, the out-apparatus temperature/humidity, and the in-apparatus environment for a period from the last replacement of the primary transfer roller to the current replacement of the primary transfer roller.

Next, the controller 21 of the image forming apparatus 2 transmits, to the server 1, the customer attribution data, the consumable component replacement information, and the working data acquired in step S2 (step S3). Note that in a case where the customer attribution data is managed by the server 1 or in a case where the customer attribution data has already been transmitted from the image forming apparatus 2, the transmission of the customer attribution data in step S3 is unnecessary.

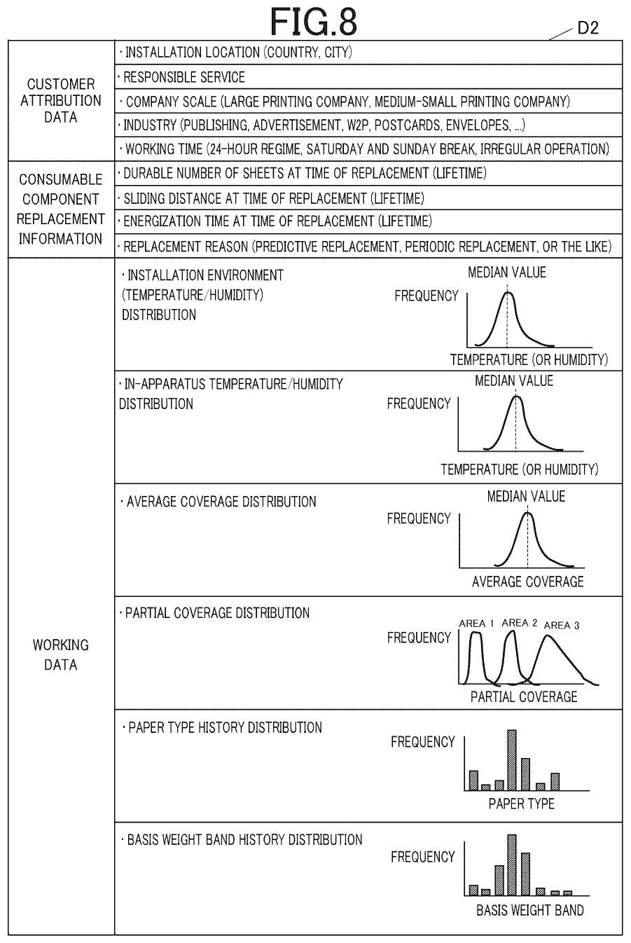

Specifically, as shown in Table D2 of FIG. 8, the above-described various data are transmitted. In the example of FIG. 8, in step S2, the installation environment (temperature and humidity distribution), the in-apparatus temperature and humidity distribution, the average coverage distribution, the partial coverage distribution, the paper type history distribution, and the basis weight band history distribution are acquired as the affecting factors. The working data corresponding to the affecting factor may be a distribution itself as shown in Table D2, or various statistical values such as a median value and an average value.

Steps S1 to S3 are performed in the plurality of image forming apparatuses 2 each time the consumable component is replaced, and thus data is transmitted from the plurality of image forming apparatuses 2 to the server 1 and accumulated in the server.

Next, the controller 11 of the server 1 calculates the lifetime coefficient using the received customer attribution data, consumable component replacement information, and working data (step S4).

Here, a method of calculating the lifetime coefficient will be described.

The controller 11 statistically analyzes the lifetime (for example, the number of durable sheets) with respect to the working data for each affecting factor in each consumable component from the accumulated working data. Then, the controller 11 calculates the lifetime coefficient indicating an increase or decrease in lifetime depending on the way of use with respect to a reference lifetime (for example, the reference number of durable sheets) of each consumable component. Note that the number of durable sheets has been described as an example, but besides the number of durable sheets, any other indicator that indicates the lifetime, such as driving time or energization time, may be used for each consumable component.

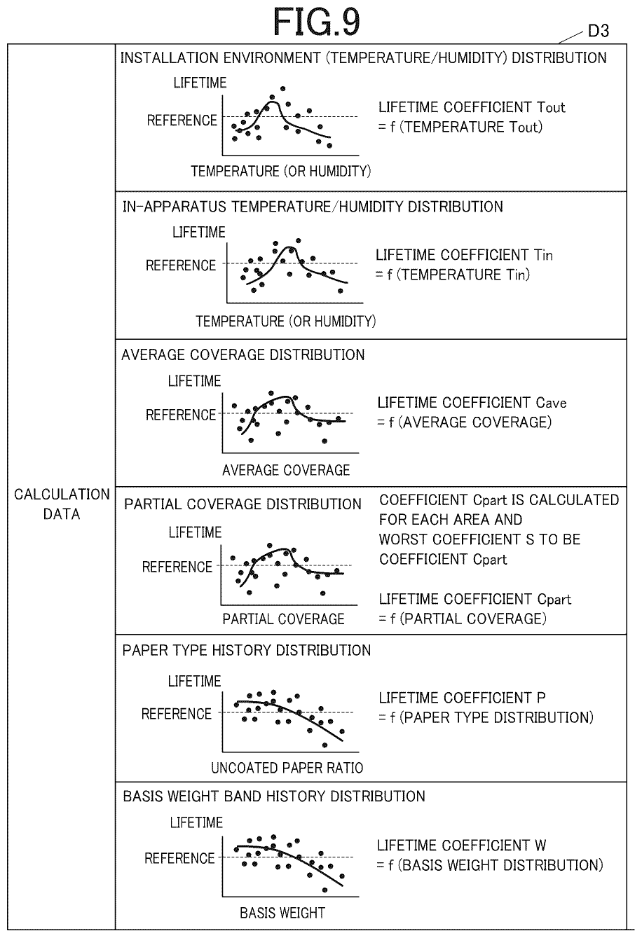

To be specific, as in the calculation data D3 illustrated in FIG. 9, the controller 11 plots the data, for each affecting factor, its working data (parameter) on the horizontal axis and its lifetime on the vertical axis. The controller 11 approximates the plotted data with a straight line, a smooth curve, or the like, thereby generating a function for calculating the lifetime coefficient (rate of increase or decrease in lifetime from the reference lifetime) using the working data as parameters. The function is represented by, for example, an equation such as coefficient TOUT=f (temperature TOUT) as in calculation data D3 shown in FIG. 9. That is, the lifetime coefficient is calculated as the lifetime when the reference lifetime is set to 1. Note that as the working data of each factor, not only statistical values such as a median value and a variance value of the distribution but also the distribution itself can be used for the calculation. In addition, the lifetime coefficient may be obtained by a function, or each factor may be divided into a plurality of parameter sections and the lifetime coefficient may be set as a constant for each section.

Note that the controller 11 can determine periodic replacement, predictive replacement, replacement of a defect caused by the consumable component, and the like from the replacement record and the replacement reason obtained from the acquired consumable component replacement information. The term “periodic replacement” refers to replacement performed at a timing when the consumable component reaches the end of its lifetime with respect to a lifetime value determined in advance for the consumable component. The predictive replacement refers to a replacement in which the consumable component is replaced when there is a possibility that the consumable component reaches the end of its lifetime by the next visit of a service person at the timing when another consumable component is replaced.

In the case of predictive replacement, the consumable component that can be originally used to the end of lifetime in terms of performance has been replaced early, and therefore, if this data is used in calculation for predicting the lifetime of the consumable component, an error may occur in lifetime prediction. Therefore, it is better that the controller 11 excludes the working data of the predictively replaced consumable component to calculate the lifetime coefficient.

Also in the case of the periodic replacement, the consumable component is replaced at a timing (time or usage amount) of its lifetime determined in advance for each consumable component, and therefore, even in a case where the function of the consumable component is not lost and the consumable component can be continuously used, the consumable component is replaced at the determined timing. Therefore, the controller 11 preferably calculates the lifetime coefficient while excluding the working data of the consumable component that has been periodically replaced.

In addition, the controller 11 updates the calculation data D3 shown in FIG. 9 every time the controller 11 obtains each working data of the replaced consumable component, and sequentially calculates the lifetime coefficient for each affecting factor.

Next, the controller 11 of the server 1 transmits the lifetime coefficient to the image forming apparatus 2 (step S5).

The controller 11 distributes, to the plurality of image forming apparatuses 2 connected to the network N, the calculation result (lifetime coefficient or the like) for each consumable component periodically or in response to the transmission request from each image forming apparatus 2. Alternatively, the result can be distributed even when a service person uses the terminal apparatus 3 to make the transmission request.

### <Lifetime Calculation Processing>

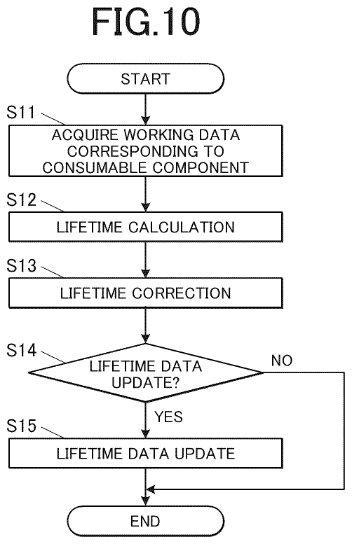

The lifetime calculation processing executed in the image forming apparatus 2 will be described with reference to FIG. 10.

The lifetime calculation processing is processing of calculating the lifetime of the consumable component by using information on the lifetime transmitted from the server 1.

Here, the information on the lifetime will be described as the lifetime coefficient. The lifetime coefficient (i.e., the function for calculating the lifetime coefficient, etc) is updated as appropriate by the above-described lifetime coefficient calculation processing.

First, the controller 21 of the image forming apparatus 2 acquires the working data corresponding to a certain consumable component (step S11). For example, when the consumable component is the intermediate transfer belt, as illustrated in FIG. 7, the controller 21 acquires the working data of the integrated energization amount and the coverage because the integrated energization amount and the coverage are the affecting factors.

Next, the controller 21 of the image forming apparatus 2 calculates the lifetime of the consumable component (step S12).

The controller 11 calculates a lifetime (remaining life) T2 of the consumable component by multiplying a remaining lifetime T1 at the time of calculation by the lifetime coefficient from the following formula (1).

lifetime (remaining life) T2=first lifetime coefficient A1×second lifetime coefficient A2 . . . ×remaining lifetime T1 at the time of calculation (1)

Note that although there are only two lifetime coefficients, the first lifetime coefficient and the second lifetime coefficient, in formula (1) above, the lifetime coefficients are multiplied by the number of affecting factors corresponding to the consumable component.

Here, the consumable component is the intermediate transfer belt, and the lifetime calculation method will be specifically described.

First, the lifetime coefficient is calculated. The lifetime coefficient is calculated for each affecting factor from a function of lifetime coefficient=f (working data) acquired in advance of the lifetime calculation processing. That is, the controller 21 calculates the first lifetime coefficient in a case where the integrated energization amount is set as an affecting factor and the second lifetime coefficient in a case where the coverage is set as an affecting factor by substituting their respective working data into the right side.

Next, the remaining lifetime at the time of calculation (calculation time point) is calculated. The remaining lifetime at the time point of calculation is obtained by subtracting the lifetime based on the working data until the current lifetime calculation time point from the lifetime stored in the storage section 25 (the initial lifetime when the image forming apparatus 2 is introduced to the customer or the lifetime at the previous lifetime calculation time point).

Next, the controller 21 of the image forming apparatus 2 corrects the lifetime (step S13).

Specifically, the controller 21 may perform the lifetime correction in consideration of a future environmental change (a seasonal change or the like), a prediction of a usage (a seasonal print job such as a New Year's card or the like), or a history of other consumable components. Note that the prediction of the future environmental change and usage and the history of other consumable components may be acquired from the image forming apparatus 2, or may be acquired from an external apparatus by the controller 11 of the server 1 from the installation information of the image forming apparatus 2.

Furthermore, for a consumable component whose durability is influenced by temperature, the controller 21 may correct the lifetime coefficient in anticipation of operating in a high-temperature environment in a season that will become hot in the future. In this case, the controller 21 needs to acquire the climate information from the external device.

Furthermore, since the durability of the blade is also influenced by the durability history of the lubricant, the controller 21 may make a correction by taking into account the durability history of the lubricant when calculating the lifetime expectancy of the blade.

Furthermore, for example, in a case where the usage of the machine by the customer is a 24-hour system or non-working on Saturday and Sunday, or there are busy and idle periods depending on the type of industry, the controller 21 may make a correction by taking into account such customer attribution data.

Furthermore, for example, based on the customer attribution data, when the apparatus is installed at a location where a service center in charge or a service person needs several days to visit, the controller 21 may correct the lifetime by further adding this point of view to the calculation result. That is, in a case where it takes several days for the visit, the correction is such that the lifetime is multiplied by a predetermined value.

Furthermore, for example, on the basis of the customer attribution data, as the way of using the machine, some image forming apparatuses are fully working for 24 hours day and night regardless of whether it is Saturday or Sunday, and some image forming apparatuses are working several times a month, and the controller 21 may correct the lifetime by adding this point of view to the result indicated by the calculation result. That is, in the image forming apparatus 2 which is fully working for 24 hours, since the deterioration of the consumable components is accelerated, the correction is made to shorten the lifetime.

Next, the controller 21 of the image forming apparatus 2 determines whether to update the lifetime data (step S14). In a case where it is determined to update (step S14; YES), the controller 21 causes the lifetime calculation processing to proceed to step S15. In a case where it is determined not to update (step S14; NO), the controller 21 ends the lifetime calculation processing.

Specifically, the controller 21 does not update the consumable component that is set not to be updated by the customer or the service person.

Further, for example, based on the customer attribution data, in a case where the installation location where the apparatus is installed is a location where the service center in charge or the service person needs several days to visit, the controller 21 does not update the lifetime and causes the user to use the consumable component until the lifetime expires.

Furthermore, for example, when the image forming apparatus has been in the working state several times a month, the controller 21 does not update the lifetime and allows the user to use the consumable component until its lifetime expires, based on the customer attribution data.

Next, the controller 21 of the image forming apparatus 2 updates the lifetime data stored in the storage section 25 (step S15), and ends the lifetime calculation processing.

### <Others>

In the above description, the lifetime calculated by the image forming apparatus 2 is corrected based on the customer attribution data, the consumable component replacement information, the working data, the climate forecast information, and the like, but the lifetime coefficient may be corrected by the server 1 based on the customer attribution data, the consumable component replacement information, the working data, the climate forecast information, and the like.

The controller 21 of the image forming apparatus 2 may cause the display part 23 to display a warning when the lifetime (remaining life) becomes shorter than a predetermined period.

Furthermore, the controller 11 of the server 1 may perform the lifetime calculation processing as the second calculation section. In this case, the operation subject of the lifetime calculation processing executed in the image forming apparatus 2 illustrated in FIG. 10 may be replaced with the controller 11 of the server 1. Furthermore, in step S11, the controller 11 of the server 1 acquires working data from the image forming apparatus 2. In step S15, the controller 11 of the server 1 updates the lifetime data of the image forming apparatus 2.

### <Effect>

As described above, the information processing apparatus (server 1) includes the acquirer (controller 11) that acquires predetermined data that affects the lifetime of the consumable component from the plurality of image forming apparatuses installed in different environments. Furthermore, the information processing apparatus (server 1) includes the first calculation section (controller 11) that calculates, based on the predetermined data, the information on the lifetime of the predetermined consumable component included in each image forming apparatus. Further, the information processing apparatus (server 1) includes the transmission controller (controller 11) that transmits the information related to the lifetime to the image forming apparatus.

Therefore, the lifetime prediction accuracy of the image forming apparatus is improved.

That is, according to the present embodiment, by acquiring and calculating various data of image forming apparatuses installed and working at different locations, it is possible to predict the lifetime of the consumable component with higher accuracy than ever before.

Furthermore, the first calculation section (controller 11) calculates information on the lifetime using the working data, and corrects the information on the lifetime using the customer attribution data.

Therefore, the lifetime prediction accuracy of the image forming apparatus is improved.

That is, by adding the prediction of the future environment change and usage to the image forming apparatus to be predicted, the lifetime prediction further matching the machine becomes possible, and it becomes possible to maximize the merit for the customer and the service person.

Furthermore, the working data includes data corresponding to a plurality of types of affecting factors that affect the lifetime, the consumable component is associated with the affecting factors that affect the lifetime of the consumable component, and the first calculation section (controller 11) calculates information on the lifetime of the consumable component for each affecting factor.

Therefore, since the working data associated with the limited affecting factors is used instead of using all the working data, the amount of information acquired from the image forming apparatus 2 can be reduced, and the load of the calculation processing of the lifetime coefficient by the server 1 can be reduced.

In addition, the consumable component replacement information also includes information regarding the presence or absence of predictive replacement, and the first calculation section (controller 11) performs calculation excluding data regarding the predictive replaced consumable component.

Therefore, the lifetime prediction accuracy of the image forming apparatus is improved.

Furthermore, the consumable component replacement information includes information indicating that each consumable component has been periodically replaced, and the first calculation section (controller 11) performs calculation while excluding data on the periodically replaced consumable component.

Therefore, the lifetime prediction accuracy of the image forming apparatus is improved.

Furthermore, the image forming apparatus 2 is an image forming apparatus including a predetermined consumable component, and includes a receiver (communicator 24) that receives information on the lifetime from the information processing apparatus described above. The image forming apparatus 2 includes the second calculation section (controller 21) that calculates the lifetime of the consumable component from the information on the life. The image forming apparatus 2 further includes a lifetime update section (controller 21) that updates the lifetime of the consumable component on the basis of a calculation result by the second calculation section.

Therefore, the information on the lifetime calculated using the information on the consumable components acquired from the plurality of image forming apparatuses is updated, and the lifetime prediction is performed using the updated information on the lifetime, so that the lifetime prediction accuracy of the image forming apparatuses is improved.

The image forming apparatus 2 includes the determiner (controller 21) determining whether to update the lifetime of the consumable component according to the customer attribution data of the own apparatus, and the lifetime updater updates the lifetime of the consumable component if the determiner determines to update the life.

Therefore, it is possible to reduce unnecessary lifetime updating.

Furthermore, the working data of the image forming apparatus 2 includes data corresponding to a plurality of types of affecting factors that affect the lifetime, the consumable component is associated with the affecting factor that affects the lifetime of the consumable component, the information on the lifetime is a lifetime coefficient of the affecting factor, and the second calculation section (controller 21) calculates the lifetime of the consumable component using the lifetime coefficient of the affecting factor associated with the consumable component.

Therefore, the lifetime prediction accuracy of the image forming apparatus is improved.

In addition, the management system 100 includes the acquisition section (controller 11) that acquires predetermined data that affects the lifetime of a consumable component from a plurality of image forming apparatuses installed in different environments. Furthermore, the management system 100 includes the first calculation section (controller 11) that calculates, based on the predetermined data, information on the lifetime of a predetermined consumable component included in each image forming apparatus. In addition, the management system 100 includes a second calculation section (controller 11) that calculates the lifetime of the consumable component of one image forming apparatus from the information on the lifetime.

Therefore, the lifetime prediction accuracy of the image forming apparatus is improved.

Furthermore, the program causes the computer of the information processing apparatus (server 1) to function as an acquisition section (controller 11) that acquires predetermined data affecting the lifetime of the consumable component from the plurality of image forming apparatuses installed in different environments, the first calculation section (controller 11) that calculates, based on the predetermined data, information on the lifetime of the predetermined consumable component included in each image forming apparatus, and the transmission controller (controller 11) that transmits the information on the lifetime to the image forming apparatus.

Therefore, the lifetime prediction accuracy of the image forming apparatus is improved.

Note that the description in the above embodiment is an example of the management system 100 according to the present embodiment, and the present invention is not limited to this. The detailed configuration and detailed operation of each section configuring the management system 100 can also be appropriately modified without departing from the spirit and scope of the present invention.

In the above description, an example in which a ROM, a hard disk, or the like is used as a computer-readable medium storing a program for executing each process has been disclosed, but the present invention is not limited to this example. As other computer-readable media, a nonvolatile memory such as a flash memory and a portable recording medium such as a CD-ROM can also be applied. In addition, a carrier wave may be applied as a medium for providing program data via a communication line.

Although embodiments of the present invention have been described and illustrated in detail, the disclosed embodiments are made for purposes of illustration and example only and not limitation. The scope of the present invention should be interpreted by terms of the appended claims.

What is claimed is:

1. An information processing apparatus comprising:
a hardware processor,
wherein the hardware processor,
acquires predetermined data that affects a lifetime of a consumable component from a plurality of image forming apparatuses installed in different environments,
calculates, based on the predetermined data, information on the lifetime of a predetermined consumable component included in each image forming apparatus, and
transmits the information on the lifetime to the image forming apparatus.

2. The information processing apparatus according to claim 1,
wherein the predetermined data includes at least the following three, customer attribution data, consumable component replacement information, and working data.

3. The information processing apparatus according to claim 2, wherein the hardware processor,
calculates the information on the lifetime using the working data, and
corrects the information on the lifetime using the customer attribution data.

4. The information processing apparatus according to claim 1, wherein the information on the lifetime is a lifetime coefficient when the lifetime of the consumable component is calculated.

5. The information processing apparatus according to claim 2,
wherein,
the working data includes data corresponding to a plurality of types of affecting factors that affect the lifetime,
the consumable component is associated with the affecting factor that affects the lifetime of the consumable component, and
the hardware processor calculates the information on the lifetime of the consumable component for each of the affecting factors.

6. The information processing apparatus according to claim 2,
wherein,
the consumable component replacement information includes information on whether there is predictive replacement, and
the hardware processor calculates excluding data related to the consumable component that is predictively replaced.

7. The information processing apparatus according to claim 2,
wherein,
the consumable component replacement information includes information indicating that each consumable component has been periodically replaced, and
the hardware processor calculates excluding data on the consumable component that is periodically replaced.

8. An image forming apparatus including a predetermined consumable component, the apparatus comprising:
a receiver that receives the information on the lifetime from the information processing apparatus according to claim 1; and
a hardware processor,
wherein the hardware processor,
calculates the lifetime of the consumable component from the information on the lifetime, and
updates the lifetime of the consumable component based on a calculation result.

9. The image forming apparatus according to claim 8,
wherein the hardware processor,
determines, according to customer attribution data of the apparatus, whether or not the lifetime of the consumable component is to be updated, and
updates the lifetime of the consumable component in a case that it is determined that the lifetime is to be updated.

10. The image forming apparatus according to claim 8,
wherein,
the working data, which is the predetermined data, includes data corresponding to a plurality of types of affecting factors that influence the lifetime,
the consumable component is associated with the affecting factor that affects the lifetime of the consumable component,
the information on the lifetime is a lifetime coefficient of the affecting factor, and
the hardware processor calculates the lifetime of the consumable component using the lifetime coefficient of the affecting factor associated with the consumable component.

11. A management system comprising:
a first hardware processor and a second hardware processor,
wherein,
the first hardware processor,
acquires predetermined data that affects a lifetime of a consumable component from a plurality of image forming apparatuses installed in different environments, and
calculates, based on the predetermined data, information on the lifetime of a predetermined consumable component included in each image forming apparatus, and
the second hardware processor calculates the lifetime of the consumable component of one image forming apparatus from the information on the lifetime.

12. A non-transitory computer-readable storage medium storing a program that causes a computer of an information processing apparatus to perform,
acquiring predetermined data that affects a lifetime of a consumable component from a plurality of image forming apparatuses installed in different environments,
calculating, based on the predetermined data, information on the lifetime of a predetermined consumable component included in each image forming apparatus, and
transmitting the information on the lifetime to the image forming apparatus.
